(19) United States
(12) Patent Application Publication
(10) Pub. No.: US 2025/0104576 A1
(43) Pub. Date: Mar. 27, 2025

(54) HIGH STRENGTH SUSTAINABLE SECURITY SEAL

(71) Applicant: METRC LLC, LAKELAND, FL (US)

(72) Inventors: DILEK DAGDELEN UYSAL, LAKELAND, FL (US); JEFFREY LANE WELLS, LAKELAND, FL (US)

(21) Appl. No.: 18/832,023

(22) PCT Filed: Feb. 8, 2023
(86) PCT No.: PCT/US2023/012631

§ 371 Date: Jul. 22, 2024

Related U.S. Application Data
(60) Provisional application No. 63/307,770, filed on Feb. 8, 2022.

(51) Int. Cl. G09F 3/03

(52) U.S. Cl. CPC G09F 3/037

(57) ABSTRACT

Embodiments of the invention pertain to a security seal/strap (seal) (10). The seal can have a main body (1) and a lock (7). The main body (1) can incorporate knots (8) that interconnect with the lock (7) to lock the seal (10). In an embodiment, the knots (8) can have one or more flaps (5) extending from a base (4) of the knot (8), such that flaps (5) engage one or more receivers (6) of the lock (7). Another embodiment can incorporate receivers (6) having ribs (14) that limit how far the receivers can open. Embodiments can be made via a single injection molding shot, and create a security seal made of a single material.

### CROSS-REFERENCE TO A RELATED APPLICATION

This application claims the benefit of U.S. provisional application Ser. No. 63/307,770, filed Feb. 8, 2022, which is incorporated herein by reference in its entirety.

### BACKGROUND OF THE INVENTION

The current security seals/straps (seals) that are tamper evident typically incorporate two pieces, the main body and the lock. The main body typically incorporates knots that engage with the lock to lock the seal. Incorporation of two pieces in the seal can limit their recyclability, as these two pieces are usually made from different materials. Two different materials are used for the main body and lock for two main reasons, namely:
1) To restrict the accessibility of the locking mechanism. To accomplish this, the lock is often inserted during a secondary process, after the main body is produced. The current seals typically either (i) have a closed end at the lock area preventing anybody from taking the lock seal apart, or (ii) have a narrow exit at the lock area, with the same size as the knots, in order to tamper proof the seal, such that any scratch marks around the exit indicates that the seal has been compromised.
2) To make the lock with a special material that provides more strength and/or more flexibility, such a metal, nylon, etc., which cannot be achieved with the main body material, e.g., due to the current designs of the knots.

Incorporating two pieces typically results in making the seals with two different injection molding steps or two different manufacturing processes. This increases the cost of the seals/straps and the energy consumption during the production.

With certain prior art security seals using two pieces, where the knots, main body and portion of the lock are a single piece, and a second piece is inserted into the lock of the first piece (see FIG. 1B), where the second piece incorporates flexible portions that flex away from the insertion axis to allow the knot to pass and relax back toward the insertion axis after the knot passes to prevent the knot from passing back through the lock unless the flexible portions are flexed away from the insertion axis, e.g., via a tool, such that the seal is tampered with. This prior art seal using two pieces attempts to prevent such tampering (flexing the flexible portions) by making the exit opening on the outlet side of the lock just a little bigger than the outer edge of the knot so that once the knot is interconnected in the lock, a potential tamperer cannot reach into the exit opening and around the knot to flex the flexible portions enough to remove the knot with indications of tempering. Sizing the exit opening in this way does not allow the seal to be produced in a single injection molding shot using a single material, as the mold cannot create the flexible portions and then retract through the “too small” exit opening. Using two pieces in this way can allow tampering by heating the two pieces to different temperatures.

### BRIEF SUMMARY

Embodiments of the subject invention pertain to a security seal/strap (seal) 10. The seal can have a main body 1 and a lock 7. The main body 1 can incorporate knots 8 that interconnect with the lock 7 to lock the seal 10. In an embodiment, the knots 8 can have one or more flaps 5 extending from a base 4 of the knot 8, such that flaps 5 engage one or more receivers 6 of the lock 7. In another embodiment, the receivers 6 have ribs 14 that limit how far the receivers can flex away from an insertion axis of the lock.

Embodiments of the subject invention can incorporate one or more of the following features:
1) A design that incorporates the locking mechanism (lock) 7 into the main body 1. Volume 1 includes a first axial section of the main body and a first section of the lock within a first mold side, and Volume 2 includes a second axial section of the main body and a second section of the lock within a second mold side, such that the two mold sides then form a combined portion of the main body and the lock. Volume 3 includes parts that can be made with either the first or second side of the mold, which can include the flaps 5.

A single material can be used in Volumes 1, 2, and 3. Using a single material enables recyclability with a local recycler without any special process such as cutting and removing a portion of the seal if a recyclable material, such as polypropylene (PP), high-density polyethylene (HDPE), is used. If a biodegradable material is used, such as polylactic acid plastic (PLA) the seal can be fully biodegradable as well.
2) Embodiments can incorporate one or more flaps 5 extending from a base 4 of one or more knots 8. A knot design that incorporates one or more flaps 5, where the flaps 5 interact with the receivers 6 of the lock 7 such that the flap(s) 5 are positioned axially farther from a longitudinal axis of the main body 1 than a receiver 6 of the lock 7 when the knot 8 is engaged with the lock 7. The specially designed knots and lock mechanism allows the seal to be made with a single injection molding shot, as a single material can be used for the main body and the lock. In comparison with a traditional knot design, the flaps 5 extending from the base 4 of the knots 8 provide a stronger lock, where the flaps 5 engage corresponding receivers 6 such that the seal can hold a higher weight or pull force. This enables the seal/strap to be made with less tensile strength such as a biodegradable material like PLA. One of the biggest challenges making a security seal with a biodegradable material is meeting the required pull strength.

A design utilizing flaps 5 can also provide more resistance and security with respect to alteration attempts to shrink and expand the seal material using cold and hot to release the knots 8 from the lock 7. Using a single material reduces the ability to take advantage of the difference between the thermal properties of two different materials to expand one material with heat and contract another material by cooling to allow the knots to be passed back out of the lock without signs of tampering.

In a specific embodiment, to provide more security the end 9 of the locking mechanism 7 can be closed using secondary process in the locking area to completely seal this area, but still use the same knots 8 with flaps 5 for a stronger seal/strap.
3) The lock 7 is made with one or more slots 11 between the receivers 6 to allow the receivers to flex outwardly to allow for the knots go through the lock and then allow the receiver to flex back to engage the flaps 5. In a specific embodiment, as shown in FIG. 3A, four slots 11 are used. After the knot passes through the lock, the flaps 5 on the knots engage with the receivers and go over the slots between the receivers 6 at least on one side to prevent somebody prying open and expanding the receivers 6 when the flaps are engaged. The locking mechanism can also be made with one, two, thee, or more than 4 slots between the receivers 6.
4) The wall 12 around the locking mechanism 7 extends out in the longitudinal direction far enough so that the last knot 8 that passed through the lock 7 will still be able to block the access of the receivers before next knot goes through the lock.
5) The flaps 5 around the knot can have rounded edges, as shown in FIGS. 6A and 6B, or cornered edges as shown in FIG. 3B.
6) Embodiment can incorporate receivers 6 having ribs 14 that limit how far the receivers can flex open to create an opening for the knot to pass.

### BRIEF DESCRIPTION OF THE DRAWINGS

FIGS. 1A-1B show current security seals, where the security seal in FIG. 1B uses a two part design wherein an inner portion of the lock is inserted into the lock housing.

FIG. 2 shows three views of an embodiment of the subject security seal, where the security seal has a main body, a lock, and multiple knots, all formed as one piece in a single injection molding shot such that a single material is used for the main body, the lock, and the knots.

FIG. 3A shows a perspective view of the outlet side of the lock, which is on the opposite side of the insertion side of the lock, showing the wall of the lock, the receivers, and the slot between the receivers.

FIG. 3B shows a perspective view of the distal end of a security seal in accordance with an embodiment of the invention, showing knots 8 each having a base and flaps extending proximally at an angle with respect to the longitudinal axis of the main body.

FIG. 3C shows a cross section of an interconnected knot and lock in accordance with an embodiment of the subject invention, in the locked position, showing receiver(s) 6, flap(s) 5, base 4 and wall 12.

FIG. 4 shows the embodiment of FIG. 3C viewed from the outlet side of the lock, showing the flaps 5 covering two of the slots between receivers 6.

FIG. 5 shows a cross section of the embodiment of FIG. 3C, where the interconnection of the knot and the lock has been rotated 90 degrees about the insertion axis of the lock, such that the flaps are shown at an angle perpendicular to the angle of the flaps make with respect to the longitudinal axis of the main body.

FIG. 6A shows an embodiment of a knot in accordance with an embodiment of the invention having flaps with a different shape than the embodiment shown in FIG. 3B.

FIG. 6B shows an embodiment of a knot in accordance with an embodiment of the invention having flaps with a different shape than the embodiment shown in FIG. 3B and different than the embodiment of FIG. 6A.

FIGS. 7A-7D show an embodiment of a security seal in accordance with the invention, where FIG. 7A shows a bottom view showing the outlet side of the lock; FIG. 7B shows a top view showing the insertion side of the lock; FIG. 7C shows a cross-section of the side view; and FIG. 7D shows a side view.

FIG. 8 shows an embodiment of a lock 7 incorporating receivers 6 having a rib 14 on the receiver, such that the rib prevents the receiver 6 from being flexed past a certain amount from the insertion axis of the lock 7.

FIGS. 9A-9D show an embodiment of a security seal in accordance with the invention, where FIG. 9A shows a bottom view showing the outlet side of the lock; FIG. 9B shows a top view showing the insertion side of the lock; FIG. 9C shows a cross-section of the side view; and FIG. 9D shows a side view.

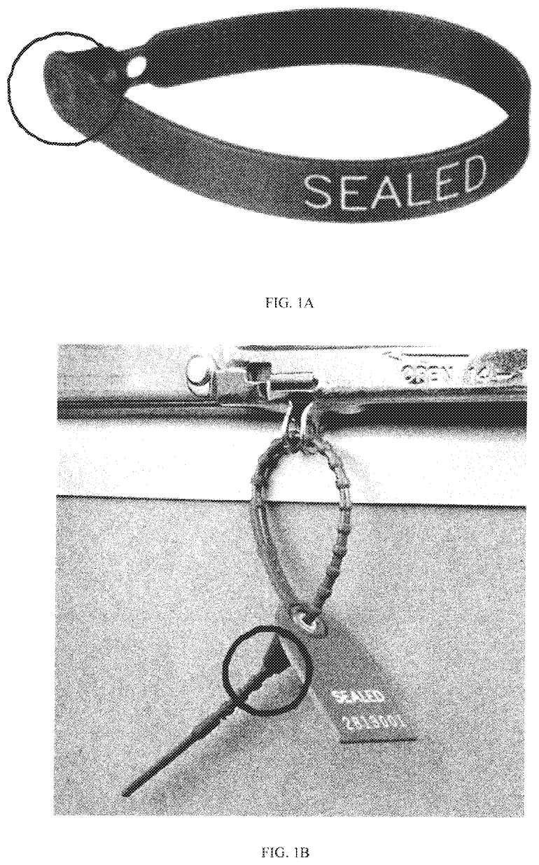

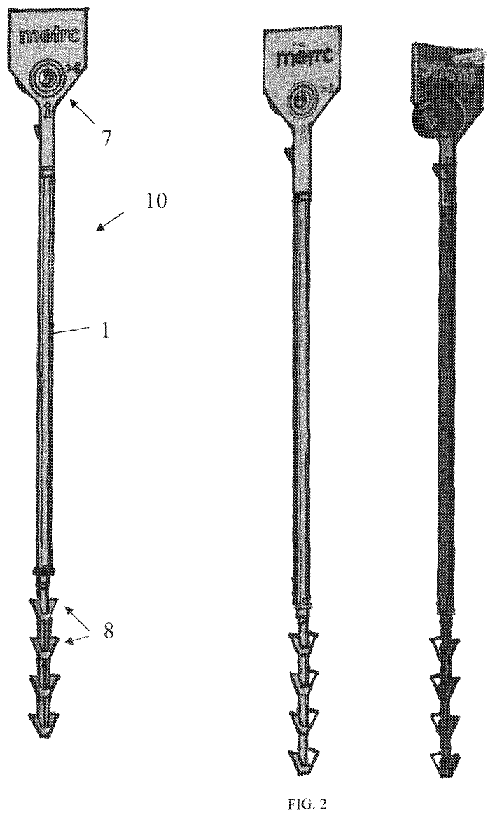

### DETAILED DESCRIPTION

Embodiments of the invention relate to a security seal having a main body 1, having a longitudinal axis, a lock 7 positioned on the main body and at least one knot 8 positioned distal from the lock 7. The lock includes one or more receivers 6 that allow the knot to pass and prevent the knot from passing back with tampering with the knot or receivers. In an embodiment, each knot of the at least one knot is positioned on the main body distal to a stop 16, where the stop is shaped such that the stop is prevented from entering the lock to pass by the receivers. Each knot is configured to interconnect with the lock such that the security seal is locked and the main body, lock, and knot form a closed loop.

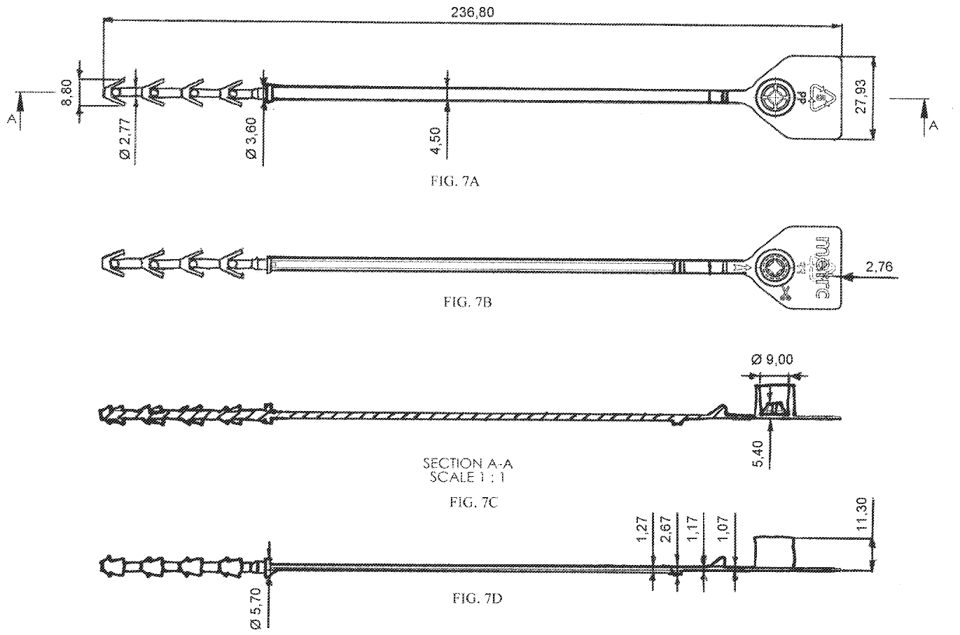

In a specific embodiment, each knot of the at least one knot incorporates one or more flaps 5 extending from a base 4 of the knot. An example of such an embodiment is shown in FIGS. 7A-7D.

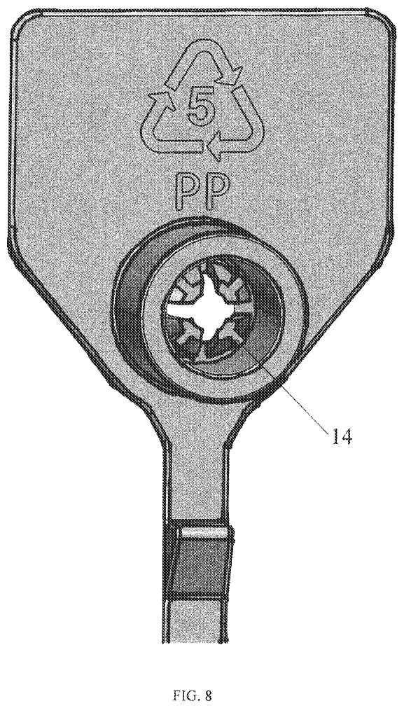

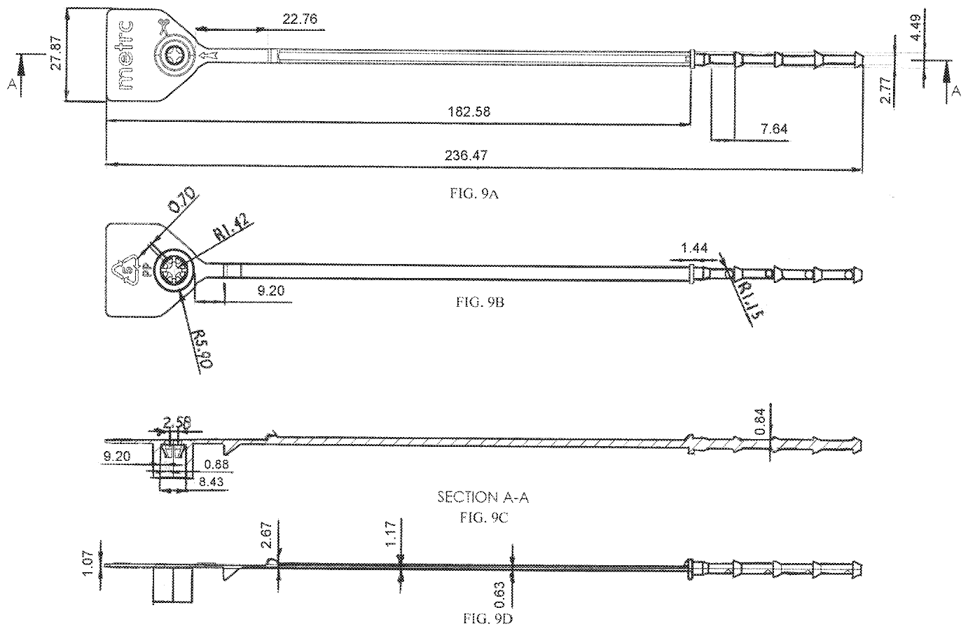

In another embodiment, each knot has a base 4 that extends from the main body to engage with receivers 6. An example of such an embodiment is shown in FIGS. 8 and 9A-9D. As the embodiment shown in FIGS. 8 and 9A-9D, as the knots 8 do not incorporate flaps 5, a rib 14 is added to one or more receivers 6 and preferably all receivers (see FIGS. 8 and 9B). The rib 14 contacts to inside of wall 12 as the receiver flexes away from the insertion axis of the lock, where the insertion axis runs through the lock from the insertion side of the lock to the outlet side of the lock. Preferably, the insertion axis is centered at the center of the lock opening. In this way, the rib limits how far the receiver can flex away from the insertion axis. When the knot is inserted into the lock, the receivers flex out, allowing the knot to pass, and then relax back so as to prevent the knot from passing back out of the lock. In an embodiment the ribs touch the wall 12 when the knot passes. In a specific embodiment, the opening defined by the inner edges of the receivers (closest to insertion axis) cannot be enlarged big enough to allow the knot to pass back through by flexing out one receiver or flexing out two receivers, because the ribs restrict the amount of flexing out. Instead, three, or four, receivers need to be flexed out to widen the opening between receivers enough to allow the knot to pass back through. In order to flex three, or four, receivers in this way, one or more indications of such flexing, i.e., tampering, are likely to show on the lock.

In an embodiment, the material of the security seal is colored and sufficient stress to the material, such as happens during tampering, produces whitened portions in the material (stress-whitening) to show tampering when PP (polypropylene) is used as the material for the security seal, the PP can be colored and such tampering can appear as causing a white color due to the physical stress on the PP, and/or scratches in the PP can be observed from the tool(s) used to flex the receivers outward.

In an embodiment incorporating flaps 5, ribs 14 can also be utilized. Referring to an embodiment with flaps 5 and no ribs 14, when the knot interconnects with the lock, by inserting the distal end of the main body into the lock from the insertion side of the lock, each flap of the knot engages with at least one receiver of the lock if a user tries to pull the knot back out of the lock 7. When the knot is interconnected with the lock such that the security seal is locked the one or more flaps of the knot are positioned axially farther from a longitudinal axis of the main body, and further from an insertion axis of the lock, than the corresponding one or more receivers of the lock. As the knot interconnects with the lock such that the security seal is locked, via a distal end of the main body being inserted into an insertion side of the lock, the main body is advanced into the lock until the one or more flaps of the knot pass the one or more receivers of the lock. The flaps then flex away from the insertion axis such that the receivers block the flaps from passing back out of the lock without sufficient force to bend the flaps back toward the distal end of the main body or the receivers and flaps being tampered with. In an embodiment using PP as the material for the seal, the PP can be colored such that tampering sufficiently to pass the knot back out of the lock causes at least a portion of the flaps, receivers, and/or other parts of the lock to turn white from the physical pressure. In this way, when the security seal is locked, the one or more receivers of the lock prevent the one or more flaps of the knot from passing back by the one or more receiver so as to allow the security seal to be unlocked, without an indication that the security seal has been tampered with.

In an embodiment, the security seal is designed so as to be manufactured in a single injection molding shot. In an embodiment, the seal comprises a first volume, a second volume, and a third volume, where the first volume incorporates a first axial section of the main body and a first section of the lock; the second volume incorporates a second axial section of the main body and a second section the lock, where the first volume and the second volume form a combined portion of the main body and the lock, and the third volume incorporates the one or more flaps. The first volume, the second volume, and the third volume are formed of a single material. In a specific embodiment, the first volume and the third volume are formed within a first mold side of a mold, and the second volume is formed within a second mold side of the mold. In another embodiment, the first volume and a first portion of the third volume are formed within a first mold side of a mold, and the second volume and a second portion of the third volume are formed within a second mold side of the mold, where the first portion of the third volume and the second portion of the third volume form the third volume. Referring to the seal shown in FIGS. 9A-9D, if desired, the seal can be formed by a first mold side creating a top portion of the seal as shown in FIG. 9D, a second mold side creating the bottom portion of the seal below the top portion. Other mold configurations can also be used. Likewise, the seal of FIG. 7D can be formed as described above for FIG. 9D.

By designing the security seal in this way, the security seal can be formed by a single injection molding shot of a single material, such that the first volume, second volume, and third volume are formed with a single injection molding shot into the mold.

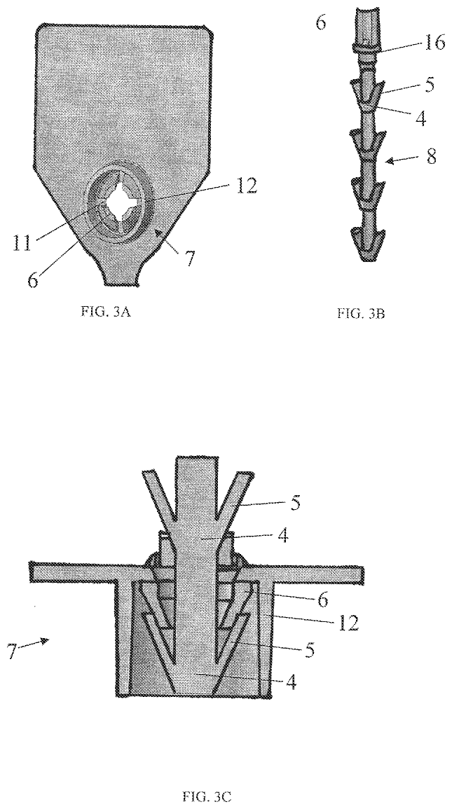

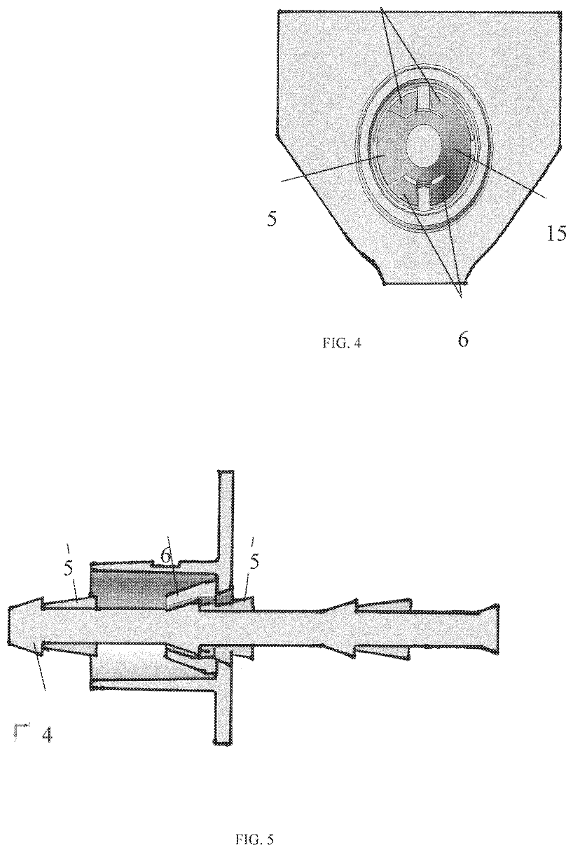

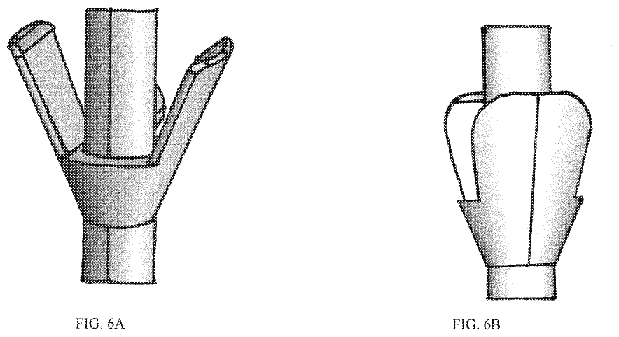

As can be seen in the embodiments of FIGS. 7A-7D and 9A-9D (see also FIGS. 8, 3C and 5), the exit opening on the outlet side of the lock is large enough to allow structures of the mold creating the internal portion of the lock (within the wall 12), such as receivers, to be removed after the single injection molding shot. This enables production of the seal via a single injection molding shot.

In an embodiment, the flaps 5 extend from the base 4 of the knot in a proximal direction at an angle with respect to the longitudinal axis of the main body, where the longitudinal axis passes through the center of the knots in FIGS. 7B and 7D, where the angle is less than 90°. In various specific embodiments, the flaps extend from the base of the knot in a proximal direction at an angle with respect to the longitudinal axis of the main body, where the angle is less than 45°; less than or equal to 80°, 70°, 60°, 55°, 50°, 40°, 35°, 30°, 25°, 21-24°, 22.5-24.5°, and/or 20°; in the range 20-25°, 25-30°, 30-35°, 35-40°, 40-45°, 45-50°, 50-55°, 55-60°, 60-70°, 70-80°, and/or 80-90°. In the embodiment shown in FIGS. 7A-7D this angle is 23.5°.

In an embodiment, the material of the security seal is a recyclable polymer. In specific embodiments, the material of the security seal is PP or HDPE. In a specific embodiment, the material of the security seal is biodegradable. In a specific embodiment, the material of the security seal is thermoplastic monomer derived from renewable organic sources. In a further specific embodiment, the material of the security seal is polylactic acid (PLA). In further embodiments, additives, such as hemp fiber, can be added to the PLA.

When the distal end of the main body is inserted into the lock, the distal end of the main body is inserted into an insertion side of the lock along an insertion axis of the lock until the flaps pass by the receivers and the security seal is locked. In embodiments such as shown in FIGS. 7A-7D and 9A-9D, where the exit opening of the lock is circular, the cross-section of the lock of the knots is circular, the cross-section of the main body between the stop 16 and the first knots, and between knots, is circular, and the longitudinal axis passes through the center of the exit opening. Other exit opening shapes can be used as well as other cross-section shapes for the knots.

In an embodiment, the flaps flex toward the longitudinal axis of the main body and the receivers flex away from the insertion axis of the lock as the knot is inserted into the lock, as the flaps are passing the receivers, until the one or more flaps of the knot pass the one or more receivers of the lock and the flaps relax back away from the longitudinal axis of the main body while the receivers relax back toward the insertion axis.

In an embodiment, the lock has one or more slots between the one or more receivers. Once the one or more flaps pass the one or more receivers, the one or more flaps can cover at least a portion of the one or more slots, which can impede tampering to “unlock” the security seal. In a specific embodiment, once the one or more flaps pass the one or more receivers, the one or more flaps cover the one or more slots. Advantageously, the flaps covering the at least a portion of the one or more slots impedes prying open and/or flexing the receivers away from the insertion axis of the lock.

In an embodiment, the lock incorporates a wall. The wall can also impede tampering to reposition the receivers and/or flaps when the security seal is locked. In an embodiment, when the security seal is locked, the outer wall of the lock makes access to the receivers more difficult without indications of tampering. In an embodiment, the wall extends from the surface of the lock face (lock height), such that the thickness of the lock face plus the height of the lock wall is at least as large as the spacing between the knots when two or more knots are used, and at least as large as the distance between the more proximal knot and the distal face of the stop 16, where stop 16 has a larger cross-sectional diameter that the entrance opening of the lock opening on the insertion side, so that the main body cannot go any further into the lock once the stop 16 contacts the lock face.

In a preferred embodiment incorporating flaps 5, the angle the flaps make with respect to longitudinal axis of the main body is equal to, or within 2-5° of, the angle the receivers 6 make with respect to the insertion axis of the lock 7. In another embodiment, utilizing a colored material of the seal, the flexing inward of the flaps 5 and the flexing outward of the receivers do not create sufficient stress to cause a whitening of the material of the seal. In a specific embodiment, a blue PP can be used as the seal material. Other colors can also be used. The embodiment of FIGS. 7A-7D incorporates two flaps. In embodiments using flaps, and embodiment with ribs and no flaps, the knots cannot pass the receivers without the receivers flexing out, preventing the knots from passing back through with receivers flexing away from insertion axis.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

### REFERENCE NUMBERS

1 main body
4 base
5 flap
6 receiver
7 lock
8 knot
9 end of locking mechanism
10 seal/strap (seal)
11 slot
12 wall
14 rib
16 stop

1. A security seal, comprising:
a main body having a longitudinal axis;
a lock positioned on the main body, wherein the lock comprises one or more receivers,
at least one knot, wherein each knot of the at least one knot is positioned on the main body distal to the lock, wherein each knot is configured to interconnect with the lock such that the security seal is locked and the main body, lock, and knot form a closed loop,
wherein when the knot interconnects with the lock such that the security seal is sealed the knot engages with at least one receiver of the lock,
wherein the security seal is configured to be created by a single injection molding shot using a first mold side of a mold and a second mold side of a mold form.

2. The security seal according to claim 1,
wherein each knot of the at least one knot comprises one or more flaps extending from a base of the knot,
wherein when the knot is interconnected with the lock such that the security seal is locked the one or more flaps of the knot are positioned axially farther from a longitudinal axis of the main body than the corresponding one or more receivers of the lock.

3. The security seal according to claim 1,
wherein the knot interconnects with the lock such that the security seal is locked via a distal end of the main body being inserted into an insertion side of the lock until the one or more flaps of the knot pass the one or more receivers of the lock,
wherein when the security seal is locked, the one or more receivers of the lock prevent the one or more flaps of the knot from passing back by the one or more receiver so as to allow the security seal to be unlocked, without an indication that the security seal has been tampered with.

4. The security seal according to claim 1,
wherein the security seal comprises a first volume, and a second volume, and a third volume, wherein the first volume incorporates a first axial section of the main body and a first section of the lock, wherein the second volume incorporates a second axial section of the main body and a second section the lock, wherein the first volume and the second volume form a combined portion of the main body and the lock, wherein the third volume incorporates the one or more flaps,
wherein the first volume, the second volume, and the third volume are formed of a single material.

5. The security seal according to claim 1,
wherein either:
i) the first volume and the third volume are formed within a first mold side of a mold, and the second volume is formed within a second mold side of the mold; or
ii) the first volume and a first portion of the third volume are formed within a first mold side of a mold, and the second volume and a second portion of the third volume are formed within a second mold side of the mold,
wherein the first portion of the third volume and the second portion of the third volume form the third volume.

6. The security seal according to claim 1,
wherein the first volume, second volume, and third volume are formed with a single injection molding shot into the mold form.

7. The security seal according to claim 2,
wherein the flaps extend from the base of the knot in a proximal direction at an angle with respect to the longitudinal axis of the main body passing through a center of the knot, wherein the angle is in the range of 22.5-24.5°.

8. (canceled)

9. The security seal according to claim 1,
wherein the security seal is formed of a single material; and
wherein the material is a recyclable polymer and/or is biodegradable.

10-12. (canceled)

13. The security seal according to claim 3,
wherein when the distal end of the main body is inserted into the lock, the distal end of the main body is inserted into an insertion side of the lock along an insertion axis of the lock until the security seal is locked, and
wherein the receivers flex away from the insertion axis of the lock as the knot is inserted into the lock, until the one or more flaps of the knot pass the corresponding one or more receivers of the lock.

14. The security seal according to claim 2,
wherein the lock comprises one or more slots between the one or more receivers,
wherein once the one or more flaps pass the one or more receivers, the one or more flaps cover at least a portion of the one or more slots.

15-16. (canceled)

17. The security seal according to claim 1,
wherein the lock comprises an outer wall,
wherein when the security seal is locked, the outer wall of the lock makes access to the receivers more difficult.

18. The security seal according to claim 1,
wherein the lock comprises a wall extending from a lock face on an outlet side of the lock, wherein at least one receiver has a rib that limits how far the at least one receiver can flex away from an insertion axis of the lock by the rib contacting the wall.

19. (canceled)

20. The security seal according to claim 18,
wherein the lock comprises four receivers.

21. The security seal according to claim 18,
wherein the wall extends away from a surface the lock face at height such that the height plus a thickness of the lock face is greater than or equal to the spacing between knots.

22. The security seal according to claim 18,
wherein the ribs of the receivers contact the wall when the knot passes the receivers.

23. The security seal according to claim 20,
wherein once the security seal is locked, the knot cannot pass back by the receivers unless at least three of the four receivers is flexed away from the insertion axis of the lock.

24. The security seal according to claim 18,
wherein the knot interconnects with the lock such that the security seal is locked via a distal end of the main body being inserted into an insertion side of the lock until the knot passes the one or more receivers of the lock, and
wherein when the security seal is locked, the one or more receivers of the lock prevent the knot from passing back by the one or more receiver so as to allow the security seal to be unlocked, without an indication that the security seal has been tampered with.

25. The security seal according to claim 18,
wherein the security seal comprises a first volume, and a second volume, and a third volume, wherein the first volume incorporates a first axial section of the main body and a first section of the lock, wherein the second volume incorporates a second axial section of the main body and a second section the lock, wherein the first volume and the second volume form a combined portion of the main body and the lock, wherein the third volume incorporates the knots,
wherein the first volume, the second volume, and the third volume are formed of a single material.

26-27. (canceled)

28. The security seal according to claim 18,
wherein the security seal is formed of a single material;
wherein the material is a recyclable polymer and/or is biodegradable.

29-31. (canceled)

32. The security seal according to claim 18,
wherein when the distal end of the main body is inserted into the lock, the distal end of the main body is inserted into an insertion side of the lock along an insertion axis of the lock until the security seal is locked,
wherein the receivers flex away from the insertion axis of the lock as the knot is inserted into the lock, until the knot passes the corresponding one or more receivers of the lock.
